(19) United States
(12) Patent Application Publication
(10) Pub. No.: US 2009/0002549 A1
(43) Pub. Date: Jan. 1, 2009

(54) ELECTRONIC CAMERA

(75) Inventor: Yuji Kobayashi, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS IMAGING CORP., Tokyo (JP)

(21) Appl. No.: 12/146,109

(22) Filed: Jun. 25, 2008

(30) Foreign Application Priority Data
Jun. 28, 2007 (JP) 2007-171057
May 7, 2008 (JP) 2008-121402

(51) Int. Cl. H04N 5/225

(52) U.S. Cl. 348/374; 348/E05.024

(57) ABSTRACT

An electronic camera includes an imaging device, a drive printed circuit board, a camera main body, an air inlet, an air outlet, and a cooling fan. The imaging device is located inside the camera main body on the optical axis of an imaging lens attached to the camera main body, and receives light passing through the imaging lens to form an image. The drive printed circuit board includes an imaging control device for controlling the imaging device. The camera main body includes a held portion that is located off the optical axis and configured to be held by an operator, and a monitor on its outer surface. The air inlet and the air outlet are located outside the held portion on the outer surface of the camera main body each on either side of the drive printed circuit board. The cooling fan generates an air flow inside the camera main body from the air inlet to the air outlet through the drive printed circuit board.

### CROSS-REFERENCE TO RELATED APPLICATIONS

This application is based upon and claims the benefit of priority from Japanese Patent Applications No. 2007-171057, filed Jun. 28, 2007 and No. 2008-121402, filed May 7, 2008, the entire contents of which are incorporated herein by reference.

### BACKGROUND OF THE INVENTION

1. Field of the Invention

The present invention relates to an electronic camera that captures an image with an imaging device on which light reflected from an object and passing through an imaging lens is focused as an optical image, or to a device with imaging function such as a mobile telephone and a portable information terminal.

2. Description of the Related Art

Electronic cameras, for example, digital cameras include an imaging device such as a charge-coupled device (CCD). The imaging device receives a light flux passing through an imaging lens, and converts the light flux into a photoelectric current. Based on the photoelectric conversion output, the imaging device acquires image data. The imaging operation of the imaging device is controlled by a drive printed circuit board having imaging control integrated circuits (IC) mounted thereon. Examples of the imaging control ICs include a timing generator (TG) device and an analog front end (AFE) device. The TG device drives the imaging device. The AFE device performs sampling, analog-to-digital (AID) conversion, automatic gain control (AGC) and the like on the image data acquired by the imaging device. If arranged distant from the imaging device, the drive printed circuit board is susceptible to electronic noise, and therefore is desirably located near the imaging device.

On the other hand, the ICs mounted on the drive printed circuit board, such as the TG device and the AFE device, form a heat generating source that generates heat along with their continuous operation, and increase surrounding temperature. In recent years, operation clock increases as the number of pixels of the imaging device increases, and thus the amount of heat generation tends to increase on the drive printed circuit board. Therefore, if the drive printed circuit board is arranged nearby, the imaging device is affected by heat noise generated by the drive printed circuit board, resulting in lower image quality. Thus, there is a need for a technology of cooling the drive printed circuit board.

Japanese Patent Application Laid-open No. H10-285441 discloses an example of a known technology for forcibly cooling an imaging device such as CCD inside an electronic camera, a heat generating component such as IC, and a printed circuit board having the heat generating component mounted thereon.

### SUMMARY OF THE INVENTION

An electronic camera according to an aspect of the present invention includes an imaging device which is located on an optical axis of an imaging lens and perpendicular to the optical axis, and on which an image of the object through an imaging lens is formed; a heatsink that is arranged in contact with a back of the imaging device; a drive printed circuit board that includes an imaging control device for controlling the imaging device, and is located close to the back of the imaging device; and a camera main body that houses the imaging device and the drive printed circuit board, and includes a held portion to be held by an operator. The held portion is located off the optical axis. The camera main body includes a monitor that is located on the back of the imaging device. The electronic camera also includes an air inlet and an air outlet that are arranged to sandwich the drive printed circuit board in a surface direction on an outer surface of the camera main body outside the held portion such that air drawn in from the air inlet flows around the drive printed circuit board; and a cooling fan that is located on a surface partially facing the air outlet inside the camera main body, and generates an air flow through the drive printed circuit board.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an external perspective view of the front of a single-lens reflex digital camera according to an embodiment of the present invention;

FIG. 2 is an external perspective view of the back of the camera;

FIG. 3 is an overhead perspective view of the back of the camera;

FIG. 4 is a cross section taken along a horizontal plane of the camera containing an optical axis;

FIG. 5 is a cross section taken along a vertical plane of the camera containing the optical axis;

FIG. 6 is an exploded perspective view of an imaging device shift mechanism;

FIG. 7 is a block diagram of a configuration example of an electronic control system of the single-lens reflex digital camera according to the embodiment;

FIG. 8 is a schematic flowchart of an example process of controlling the operation of a cooling fan according to a detected temperature;

FIG. 9 is a schematic flowchart of an example process of controlling the operation of the cooling fan in live view mode;

FIG. 10 is a schematic flowchart of an example process of controlling the operation of the cooling fan in continuous shooting mode;

FIG. 11 is a cross section taken along a horizontal plane of a camera containing an optical axis according to a modification of the embodiment; and

FIG. 12 is a cross section taken along a vertical plane of the camera shown in FIG. 7 containing the optical axis.

### DETAILED DESCRIPTION OF THE PREFERRED EMBODIMENTS

Exemplary embodiments of the present invention are explained in detail below with reference to the accompanying drawings. An electronic camera of an embodiment of the present invention is described as, for example, a single-lens reflex digital camera with interchangeable lenses.

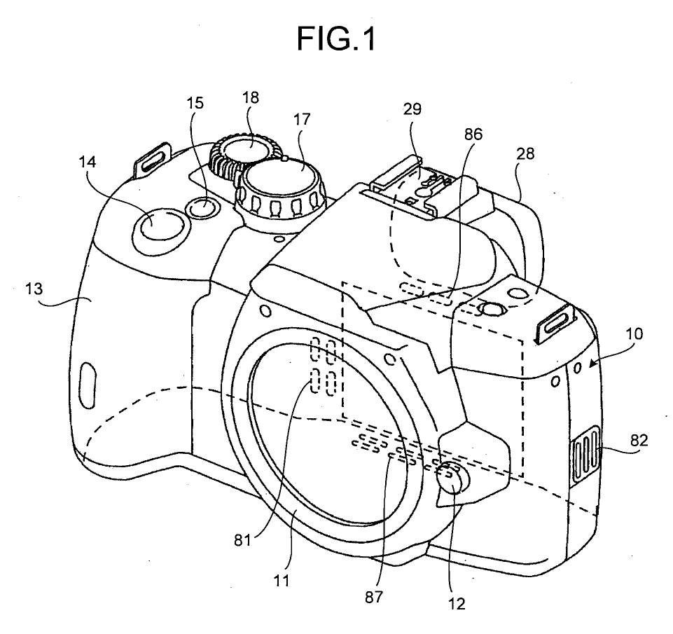

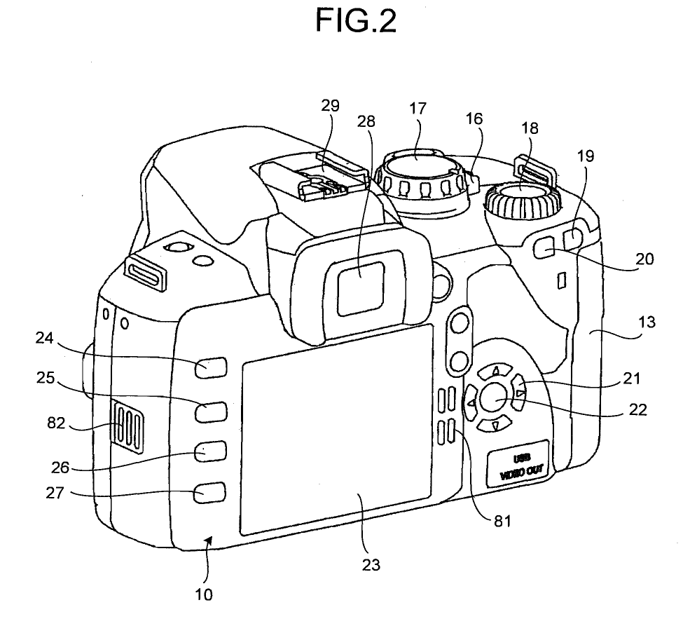

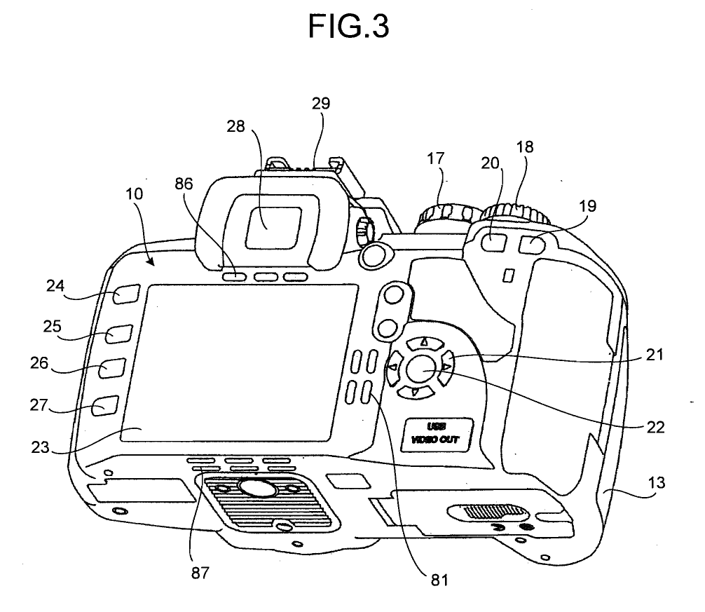

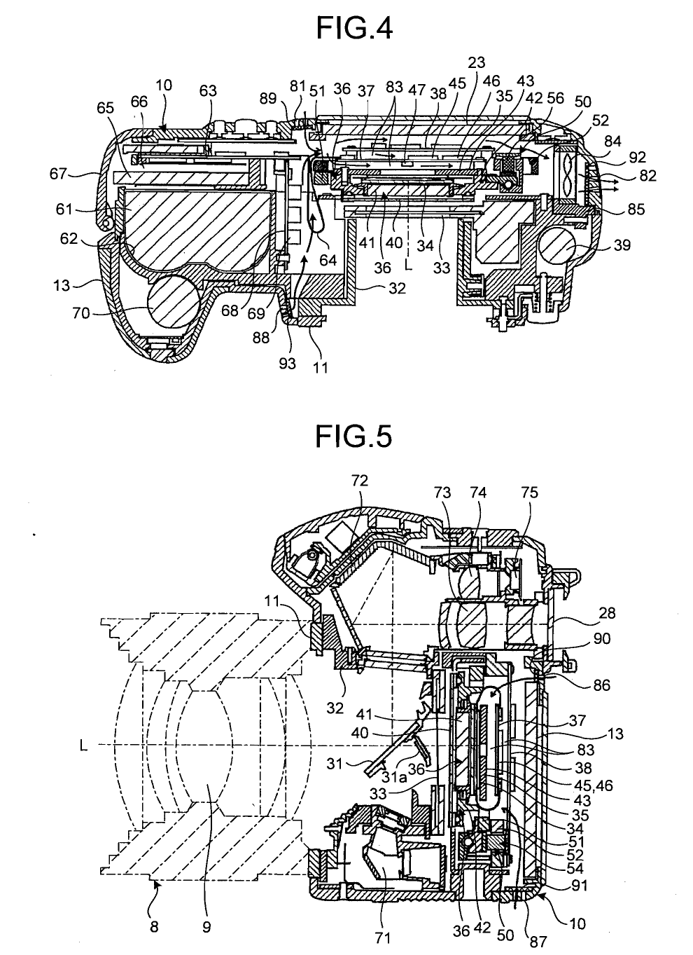

FIG. 1 is an external perspective view of the front of a single-lens reflex digital camera according to an embodiment of the present invention. FIG. 2 is an external perspective view of the back of the camera. FIG. 3 is an overhead perspective view of the back of the camera. FIG. 4 is a cross section taken along a horizontal plane of the camera containing an optical axis. FIG. 5 is a cross section taken along a vertical plane of the camera containing the optical axis.

A configuration of a single-lens reflex digital camera according to an embodiment of the present invention is schematically described with reference to FIGS. 1 to 3. The single-lens reflex digital camera includes a camera main body 10, and an interchangeable lens unit 8 including an imaging lens 9 (see FIG. 5) that is interchangeably attached to a substantially center of the front of the camera main body 10. The camera main body 10 defines the external shape of the camera, and has as a whole a horizontally a little elongated shape. The camera main body 10 includes a lens mount ring 11 for interchangeably mounting the interchangeable lens unit 8 including the imaging lens 9. Specifically, the lens mount ring 11 is used to attach the interchangeable lens unit 8 to the substantially center of the front of the camera main body 10, which is on the optical axis L of the imaging lens 9. Beside the lens mount ring 11 is a lens attach/detach button 12. The camera main body 10 further includes a grip 13 that is raised to form a handgrip held by an operator with his/her right hand when he/she takes a photograph or the like. The grip 13 is located at the edge of the camera main body 10 on the left side, viewed from the front of the camera, of a vertical plane of the camera containing the optical axis L. The top of the grip 13 is provided with, for example, a release button 14 and an exposure compensation button 15 that an operator can operate with his/her finger while holding the grip 13. On the right side, viewed from the front of the camera, of the top of the camera main body 10 are arranged a mode dial 17 including a power switch 16, and a control dial 18 for enabling switch between various modes.

The camera main body 10 further includes, on the back of the grip 13, an autofocus (AF) frame selection button 19, a one-touch white balance button 20, adjustment buttons 21 for adjusting white balance, AF, etc., and an OK button 22. The camera main body 10 is provided on the back with a liquid crystal display (LCD) monitor 23 at a position on the optical axis L and adjacent to the grip 13. The LCD monitor 23 is a thin film transistor (TFT) monitor that displays, in addition to an image captured by the camera, various settings and adjustment items. The LCD monitor 23 occupies about half of the back area, and is a rectangular display panel. On the left side, viewed from the back of the camera, of the LCD monitor 23 are arranged buttons such as a play button 24, an erase button 25, a menu button 26, and an information display button 27. The camera main body 10 is further provided with a viewfinder 28 and a hot shoe 29 above the LCD monitor 23 on the back. An operator looks through the viewfinder 28 to see an image to be captured by the camera. The hot shoe 29 allows an external flash to be connected to the camera.

An interior configuration of the camera main body 10 is explained below with reference to FIGS. 4 and 5. The camera main body 10 includes, on the front side thereof, a built-in mirror member such as a quick-return mirror 31 on the optical axis L, and a mirror box 32. The lens mount ring 11 is attached to the front of the mirror box 32. On the optical axis L, an imaging unit 36 including a focal-plane shutter 33, an imaging device 34 and a heatsink 35, a drive printed circuit board 37, a printed circuit board 38, etc. are arranged in this order toward the depth from the quick-return mirror 31, such that they are perpendicular to the optical axis L and in parallel with one another. The focal-plane shutter 33 is opened and closed by a motor 39. The motor 39 is also used to move the quick-return mirror 31 up and down.

The imaging unit 36 includes a dust-proof filter 40, an optical low pass filter 41, and the imaging device 34, which are arranged in this order from the front side and unitized by a holder 42. The dust-proof filter 40 is provided with piezoelectric devices around it. As the piezoelectric devices vibrate at a predetermined frequency, the dust-proof filter 40 also vibrates, which removes dust from a filter surface. The imaging device 34 is rectangular, and performs photoelectric conversion of light reflected from an object and focused on the imaging plane through the imaging lens 9 to form an image. While, in this embodiment, a CCD image sensor is cited as the imaging device 34 by way of example and without limitation, the imaging device 34 can be a complementary metal oxide semiconductor (CMOS) image sensor or the like. The heatsink 35 is made of metal having high thermal conductivity, and is larger than the imaging device 34. The heatsink 35 is fixed to the holder 42 in contact with the back of the imaging device 34, thus serving as an imaging device fixing plate. To a surface (back) of the heatsink 35 is directly attached a heat storage material 43. The heat storage material 43 absorbs and stores heat while exhibiting a phase change and melting at a temperature of, for example, 48° C. A latent heat storage material with thermal memory is used for the heat storage material 43. For example, as the heat storage material 43 can be used integration of inorganic heat storage material and synthetic resin, or organic heat storage material containing synthetic resin microcapsules. The heat storage material 43 is a thin sheet coated with an adhesive having high conductivity.

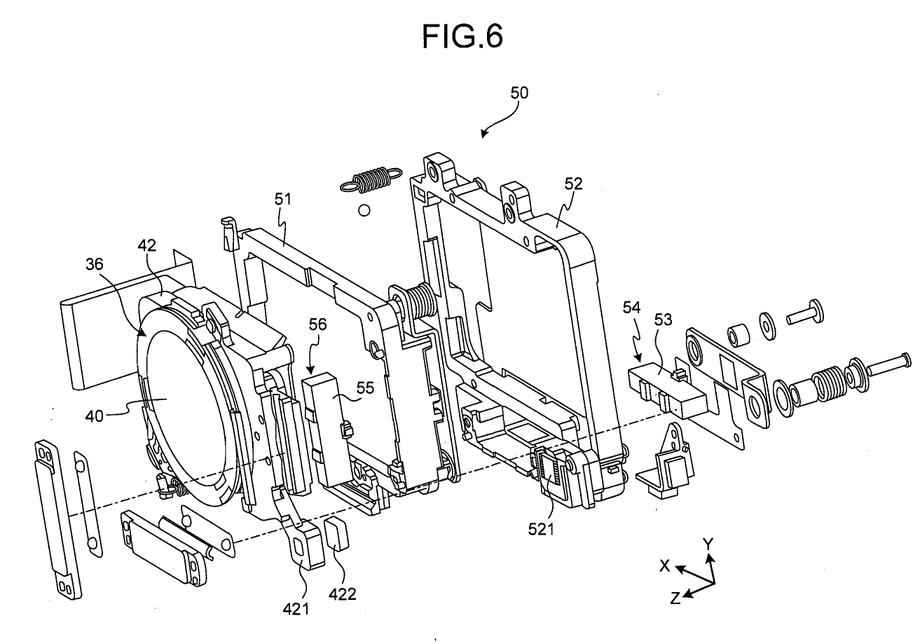

Inside the camera main body 10 is provided an imaging device shift mechanism 50 that drives and shifts the holder 42 having mounted the imaging device 34 thereon to compensate for camera shake or blur that results from shaking of the lens due to hand-held shooting. Although various configurations are available for the imaging device shift mechanism 50, in this embodiment, its actuator is a vibrator that, when applied with a voltage of a predetermined frequency, causes in a driving unit elliptical vibration composed of longitudinal vibration and bending vibration. FIG. 6 is an exploded perspective view of the imaging device shift mechanism 50. As shown in FIG. 6, the imaging device shift mechanism 50 shifts the holder 42, on which the imaging device 34 is mounted together with the dust-proof filter 40 and the optical low pass filter 41, in an X-axis direction and a Y-axis direction perpendicular to the optical axis L (an X-axis direction). The imaging device shift mechanism 50 includes an X frame 51 and a frame member 52. The X frame 51 is located on the optical axis L, and supports the holder 42 such that the holder 42 is movable in the Y-axis direction. The frame member 52 holds the X frame 51 such that the X frame 51 is movable in the X-axis direction. The position of the frame member 52 is fixed inside the camera main body 10.

The imaging device shift mechanism 50 includes an X-axis driving mechanism 54 and a Y-axis driving mechanism 56. The X-axis driving mechanism 54 includes an actuator 53 that shifts the X frame 51 in the X-axis direction with respect to the frame member 52. The Y-axis driving mechanism 56 includes an actuator 55 that shifts the holder 42 in the Y-axis direction with respect to the X frame 51. Correspondingly to the amount of camera shake detected, the imaging device shift mechanism 50 shifts the holder 42 together with the X frame 51 in the X-axis direction with respect to the frame member 52 as well as shifting it in the Y-axis direction with respect to the X frame 51. With this, the imaging device 34 mounted on the holder 42 shifts to compensate for camera shake in the X-axis and Y-axis directions in an X-Y plane. A position detector includes an arm 421 that extends from a portion of the holder 42. The arm 421 is fitted with a magnet 422 magnetized in the width direction. On the frame member 52 are arranged a plurality of hall elements 521 for detecting a change in magnetic force at the edge of the magnet 422. The magnet 422 and the hall elements 521 are formed in pair and face each other. The hall elements 521 are arranged to be able to perform position detection in two-dimensional directions, i.e., the X-axis and Y-axis directions, in a plane. With this, the position detector can detect a position of the holder 42 being moved by the X-axis driving mechanism 54 and the Y-axis driving mechanism 56 in two-dimensional directions perpendicular to the optical axis L of the imaging lens 9.

The drive printed circuit board 37 has imaging control IC devices, such as a TG device 45 and an AFE device 46, mounted thereon for controlling the imaging operation of the imaging device 34. The drive printed circuit board 37 is located on the back side and spaced apart a little from the imaging device 34 and the heatsink 35. The drive printed circuit board 37 is fixed to the holder 42. The TG device 45 is a drive IC that generates an operation clock for driving the imaging device 34. The AFE device 46 controls the imaging device 34 to perform sampling of an analog signal acquired by the imaging device 34 through photoelectric conversion, and then perform A/D conversion and AGC to obtain digital data corresponding to a captured image. By arranging the drive printed circuit board 37 on the back side immediately behind the imaging device 34, the effect of electronic noise decreases. On the center of a surface, i.e., the surface facing the imaging device 34, of the drive printed circuit board 37 is mounted a temperature sensor 47 that senses the surrounding temperature. The printed circuit board 38 has control circuits, etc., mounted thereon for controlling, for example, the imaging device shift mechanism 50. The printed circuit board 38 is located on the back side of the drive printed circuit board 37 with a spacing therebetween. The printed circuit board 38 is fixed to the frame member 52.

Inside the grip 13 of the camera main body 10 is provided a battery chamber 62 that houses a battery 61. Also inside the grip 13, a main circuit board 63 is provided on the back side for controlling the camera and performing image processing, image compression, data storage, and the like. The main circuit board 63 is arranged perpendicular to the optical axis L. On the main circuit board 63 is mounted memory such as a synchronous dynamic random access memory (SDRAM). The main circuit board 63 is electrically connected to the drive printed circuit board 37 via a flexible circuit board 64. The flexible circuit board 64 is formed to have a width not to close the inner space. Between the battery chamber 62 and the main circuit board 63 is formed a memory slot 66 for inserting a memory card 65. The memory slot 66 is usually closed by an open/close cover 67. With this configuration, image data acquired from an image captured by the imaging device 34 and digitalized by the AFE device 46 is subjected to necessary processing. Thereafter, the image data is once stored in the SDRAM, and then stored in the memory card 65. Inside the grip 13, in the space outside the battery chamber 62 on the optical axis L side, i.e., on the center side, is provided a power source circuit board 68 with its surface extending from the front side to the back. The power source circuit board 68 is arranged perpendicular to the main circuit board 63. On the power source circuit board 68 are mounted power source circuits 69 for supplying power from the battery 61 to the circuit boards 37, 38, and 63. In front of the battery chamber 62 is an aluminum electrolytic capacitor 70 for flash lamp.

Inside the camera main body 10, a submirror 31a is arranged behind the quick-return mirror 31 on the optical axis L. On the non-reflective side of the quick-return mirror 31 is provided an AF sensor unit 71 that receives light reflected from the submirror 31a and detects a defocus amount. On the other hand, on the reflective side of the quick-return mirror 31 are provided a roof mirror (pentaprism) 72, an eyepiece lens 73, and the like. Above the eyepiece lens 73 are arranged a photometric lens 74 and a photometric sensor 75 for photometry based on a portion of light reflected from the roof mirror 72.

In such a configuration, the drive printed circuit board 37 is a main heat generating source for the imaging device 34. Accordingly, this embodiment provides a cooling mechanism for forcibly cooling the drive printed circuit board 37 without substantial change in camera configuration. Specifically, on the back of the camera main body 10, a plurality of slit-like air inlets 81 are formed between the LCD monitor 23 and the adjustment buttons 21 (just right side of the LCD monitor 23 in FIG. 2). Besides, a plurality of slit-like air outlets 82 are formed on the side of the camera main body 10 opposite to the side with the grip 13, i.e., the right side viewed from the front of the camera. The air outlets 82 are located at the center in the vertical direction of the camera main body 10 correspondingly to the air inlets 81. In other words, the air inlets 81 and the air outlets 82 are arranged to sandwich the drive printed circuit board 37 (the LCD monitor 23), in the surface direction from both sides thereof, on the outer surface of the camera main body 10 outside the grip 13. With this, as indicated by arrows in FIG. 4, an air-flow path 83 is formed such that air drawn in from the air inlets 81 flows around the drive printed circuit board 37, and is released from the air outlets 82. Further, a cooling fan 84 and the air outlets 82 are arranged correspondingly to the shape of the exterior (cover) of the camera main body 10. The size of a region in which are formed the numerous air outlets 82 is smaller than an outlet surface for exhausting air from the cooling fan 84. The spacing between the cooling fan 84 and the air outlets 82 is surrounded or closed by side walls. The outlet surface can be closer to a surface of the region having the air outlets 82 that faces thereto to form a cover of the cooling fan 84. In this case, it is required to prevent hot air drawn in by the cooling fan 84 from escaping through the sides. The cooling fan 84 forcibly generates an air flow circulating along the air-flow path 83. In other words, the cooling fan 84 blows air drawn in from the air inlets 81 so that the air flows around the drive printed circuit board 37 and is released from the air outlets 82. The cooling fan 84 is fixed by a fan fixing holder 85 inside the camera main body 10.

In addition, on the back of the camera main body 10, air inlets 86 are formed above the upper periphery of the LCD monitor 23. Besides, on the bottom of the camera main body 10, air inlets 87 are formed below the lower periphery of the LCD monitor 23. The air inlets 86 and 87 are a plurality of slit holes arranged along the top and base of the LCD monitor 23. The air inlets 86 and 87 are also arranged to sandwich the LCD monitor 23 (the drive printed circuit board 37), in the surface direction, on the outer surface of the camera main body 10 outside the grip 13.

Further, on the front of the camera main body 10, a front air inlet 88 is formed in the periphery of the lens mount ring 11 and on the front side of the power source circuit board 68. Air drawn in from the front air inlet 88 and blown by the cooling fan 84 flows around the power source circuit board 68 and the drive printed circuit board 37, and is released from the air outlets 82.

Inside the camera main body 10, the air inlets 81, 86 and 87, the air outlets 82, and the front air inlet 88 are provided with sponge or porous filters 89 to 93 having air permeability, respectively. The filters 89 to 93 are closely attached to the inner surface of the exterior cover of the camera. The filters 89 to 93 prevent dust from entering into the camera main body 10 through the air inlets 81, 86 and 87, the air outlets 82, and the front air inlet 88 when the cooling fan 84 is blowing air and when it stops.

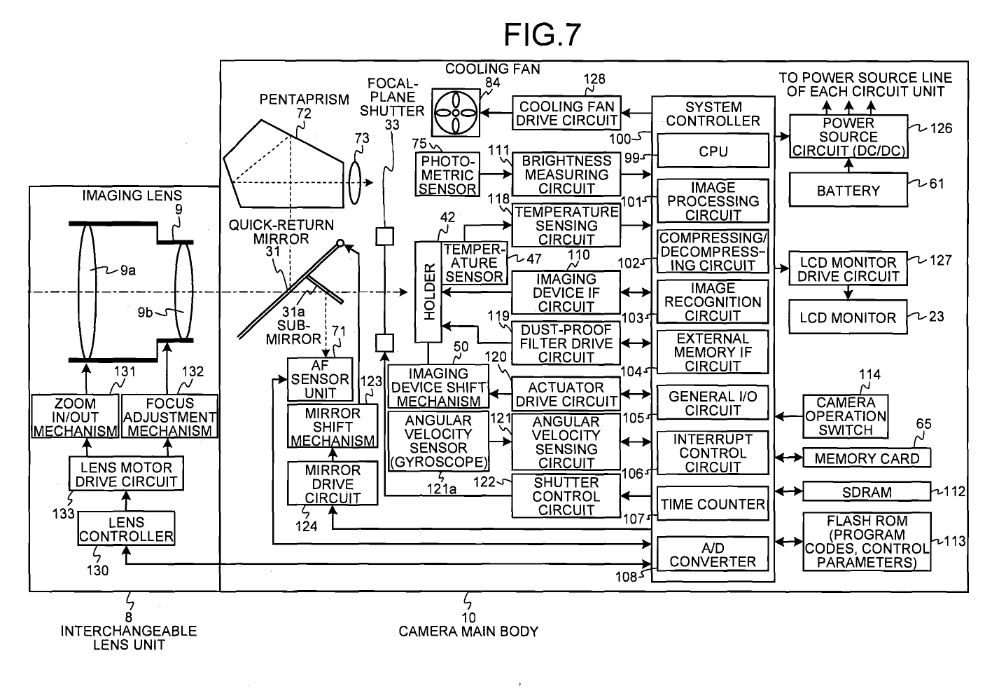

Described below is a configuration of an electronic control system of the single-lens reflex digital camera according to the embodiment configured as above. FIG. 7 is a block diagram of a configuration example of an electronic control system of the single-lens reflex digital camera according to the embodiment. The single-lens reflex digital camera includes a system controller (micro computer) 100 that controls the overall operation of the camera. The system controller 100 includes a central processing unit (CPU) 99 and a plurality of circuit blocks, and is mounted on the drive printed circuit board 37. The circuit blocks includes, for example, an image processing circuit 101, a compressing/decompressing circuit 102, an image recognition circuit 103, an external memory interface (IF) circuit 104, a general input/output (I/O) circuit 105, an interrupt control circuit 106, a time counter 107, and an A/D converter 108. The CPU 99 and the circuit blocks are connected via a control line or a control bus with one another.

The image processing circuit 101 performs predetermined image processing, such as gamma correction, color conversion, pixel conversion and white balance adjustment, on image data captured by the imaging device 34 and acquired through an imaging device IF circuit 110. The compressing/decompressing circuit 102 compresses the image data subjected to image processing by the image processing circuit 101, and also decompresses compressed image data read out of the memory card 65. The image recognition circuit 103 extracts features of the face of a person as an object from image data captured by the imaging device 34 using a predetermined image processing algorithm.

The external memory IF circuit 104 functions as a bridge between the memory card 65, a SDRAM 112 and a flash read only memory (ROM) 113, and a data bus inside the system controller 100. The flash ROM 113 stores therein a control program for controlling the overall operation, control parameters, and the like. In the system controller 100, the CPU 99 loads the control program stored in the flash ROM 113 and executes it to control the operation of the camera. The SDRAM 112 temporarily stores therein image data acquired through the imaging device IF circuit 110, and is used as a work area of the system controller 100. The memory card 65 is a removable recording medium such as a semiconductor nonvolatile memory or a compact hard disk drive (HDD).

The general I/O circuit 105 is used as an input terminal for a camera operation switch 114 connected to the system controller 100 as well as an output terminal for a control signal for controlling peripheral circuits. The interrupt control circuit 106 generates an interrupt signal in response to the camera operation switch 114 and the time counter 107, and the like. The time counter 107 counts clock signals to generate a timing signal necessary for system control. The A/D converter 108 performs A/D conversion of the detection output of various sensors, including the temperature sensor 47, in the camera.

The imaging device 34, such as CCD, provided in the imaging unit 36 unitized by the holder 42 converts light rays reflected from an object and focused by the imaging lens 9 into an analog photoelectric signal. The imaging device IF circuit 110 generates a timing pulse for driving the imaging device 34, and reads the analog photoelectric signal obtained through the photoelectric conversion by the imaging device 34. Besides, the imaging device IF circuit 110 performs A/D conversion of the analog electrical signal, and sends it as image data to the system controller 100.

Together with a temperature sensing circuit 118, the temperature sensor 47 constitutes a temperature sensing unit. The temperature sensor 47 can be a device whose resistance varies according to the temperature or a semiconductor temperature sensor. As described above, the temperature sensor 47 is located at the center of the back of the drive printed circuit board 37 (the surface facing the imaging device 34) to sense the temperature around the drive printed circuit board 37. Together with a brightness measuring circuit 111, the photometric sensor 75 constitutes a brightness measuring unit, and measures the brightness of an object from the viewfinder. The cooling fan 84 is connected to the system controller 100 via a cooling fan drive circuit 128, and is driven under the control of the system controller 100.

A dust-proof filter drive circuit 119 outputs a drive signal to the piezoelectric devices to remove dust from the dust-proof filter 40 in the imaging unit 36 by vibration. The imaging device shift mechanism 50 is used for the two-dimensional displacement of the holder 42 that holds the imaging unit 36 in the X-Y plane perpendicular to the optical axis L of the imaging lens 9. The imaging device shift mechanism 50 is driven by an electromagnetic drive motor as an actuator. An actuator drive circuit 120 outputs a drive signal to the actuator. The system controller 100 shifts the imaging unit 36 (the holder 42) according to camera shake to prevent image quality from degrading, thereby performing image stabilization. Camera shake is detected by an angular velocity sensor 121a using a gyroscope and an angular velocity sensing circuit 121 that amplifies the output of the angular velocity sensor 121a. Based on the output of the angular velocity sensing circuit 121, the system controller 100 outputs a control signal to the actuator drive circuit 120 to correct camera shake.

The focal-plane shutter 33 is arranged in front of the imaging unit 36 (on the object side), and controls the exposure time of the imaging device 34. The focal-plane shutter 33 is opened/closed according to a control signal output from a shutter control circuit 122. The system controller 100 controls the shutter control circuit 122 based on the exposure time. The quick-return mirror 31 is a beam splitter that guides light rays having passed through the imaging lens 9 to the imaging device 34 and an observation optical system (the pentaprism 72 and the eyepiece lens 73). A submirror 31a is supported at the center of the quick-return mirror 31. The center of the quick-return mirror 31 is translucent, and light rays having passed through the translucent portion are reflected by the submirror 31a and guided to the AF sensor unit 71. The quick-return mirror 31 is selectively positioned by a mirror shift mechanism 123 on the optical path of the imaging lens 9 (down position) or off the optical path (up position). A mirror drive circuit 124 sends a drive signal to an actuator in the mirror shift mechanism 123. When the quick-return mirror 31 is at the down position and the submirror 31a is on the optical path, light rays having passed through the imaging lens 9 are guided to the AF sensor unit 71. Accordingly, the system controller 100 sets the submirror 31a on the optical path when calculating a defocus amount (an out-of-focus amount) from the output of the AF sensor unit 71. On the other hand, the system controller 100 sets the submirror 31a off the optical path during the shooting. For example, a known phase difference AF sensor can be used as an AF sensor in the AF sensor unit 71.

A power source circuit (direct current-to-direct current: DC/DC converter) 126 converts the voltage of the battery 61 into voltages required to the system controller 100 and peripheral circuits thereof. Power distribution is controlled according to an instruction from the system controller 100. An LCD monitor drive circuit 127 drives the LCD monitor 23. In response to a drive signal from the LCD monitor drive circuit 127, the LCD monitor 23 displays image data in live view mode, various menus or the like. The camera operation switch 114 is a group of keys or buttons for operating the camera including the release button 14, the exposure compensation button 15, a mode set switch (e.g. a shooting mode switch), a live view switch, and the power switch 16.

The interchangeable lens unit 8 is controlled by a lens controller 130. The lens controller 130 is connected to the system controller 100 via a communication line, and performs a predetermined control procedure according to an instruction from the system controller 100. A zoom in/out mechanism 131 is used for zoom operation to change the focal length of a zoom lens 9a included in the imaging lens 9. A focus adjustment mechanism 132 change the focal point of a focus lens 9b included in the imaging lens 9. A lens motor drive circuit 133 feeds a drive signal to a motor provided in each of the mechanisms 131 and 132. The lens controller 130 controls the lens motor drive circuit 133 to thereby control the zoom operation and focus adjustment of the imaging lens 9.

Explained below is the forcible cooling operation performed by driving the cooling fan 84. The cooling fan 84 generates, when driven, an air flow to be released from the air outlets 82. Accordingly, air drawn in from the air inlets 81 on the back of the camera main body 10 flows along the air-flow path 83 around the drive printed circuit board 37 and is released from the air outlets 82 on the side of the camera main body 10. In other words, air drawn in from the air inlets 81 flows between the drive printed circuit board 37 and the printed circuit board 38 as well as between the drive printed circuit board 37 and the imaging device 34 (the heatsink 35) in the surface direction. Thus, it is possible to effectively perform forcible cooling of the drive printed circuit board 37 that forms a heat generating source, and reduce the effect of heat noise on the imaging device 34.

At the same time, the heatsink 35 can also be forcibly cooled by the air flow passing thereby in the surface direction, which effectively cools the imaging device 34 in contact with the heatsink 35. One approach to cooling the imaging device is to dissipate heat by heat conduction. In this approach, the heatsink in contact with the imaging device is fixed in contact with the exterior cover so that heat generated from the imaging device can be conducted through the heatsink to the exterior cover and thereby is dissipated (e.g., see Japanese Patent Application Laid-open Nos. 2005-252547 and 2004-104632). Although, in this embodiment, the imaging device 34 is movable by the imaging device shift mechanism 50 and such dissipation of heat by heat conduction is not applicable, the imaging device 34 can be forcibly cooled in the above manner.

The cooling fan 84 also blows, when driven, air drawn in from the air inlets 86 and 87 located above and below the LCD monitor 23, respectively, so that the air flows along the air-flow path 83 around the drive printed circuit board 37 and is released from the air outlets 82 to outside the camera main body 10. With this, it is possible to effectively perform the overall forcible cooling of the drive printed circuit board 37.

The cooling fan 84 also blows, when driven, air drawn in from the front air inlet 88 located in the periphery of the lens mount ring 11 and on the front side of the power source circuit board 68, so that the air flows around the power source circuit board 68 and the drive printed circuit board 37 and is released from the air outlets 82. With this, the forcible cooling of the drive printed circuit board 37 can be improved, and heat generated by the power source circuit board 68 can also be effectively cooled.

The forcible cooling operation is performed, i.e., the cooling fan 84 is driven, when, for example, an operator holds the grip 13 with his/her right hand, holds the lens unit with his/her right hand if required, and looks through the viewfinder 28. At this time, any of the air inlets 81, 86 and 87, the air outlets 82, and the front air inlet 88 are not covered by the operator's hand because they are arranged on the outer surface of the camera main body 10 outside the grip 13. Thus, although each operator holds the grip 13 in different manners depending on shooting conditions and also the way to hold it varies between individuals, forcible cooling can be reliably performed regardless of the manner in which the operator holds the grip 13. Accordingly, the operator can hold the grip 13 without particularly paying attention to the air inlets 81, 86 and 87, the air outlets 82, and the front air inlet 88, which ensures the operability of the camera. In addition, an air flow, which forcibly cools the drive printed circuit board 37, etc. and is released from the air outlets 82, flows toward a side of the camera main body 10, and is not discharged to the operator's side including the operator's face. Therefore, the operator can operate the camera in comfort without suffering from air discharged therefrom.

The timing to drive the cooling fan 84 is described below. The cooling fan 84 is not being driven all the time, but driven selectively, i.e., only when required as when the temperature rises due to the heat generated by the drive printed circuit board 37. The temperature sensor 47 always senses the temperature around the drive printed circuit board 37 that serves as a heat source for the imaging device 34. Moreover, the heat storage material 43 is attached to the heatsink 35 that faces the drive printed circuit board 37. The heat storage material 43 absorbs heat while exhibiting a phase change and melting when a temperature around the air-flow path 83 rises to, for example, about 48° C. due to heat generated by the drive printed circuit board 37. With this, the time until the temperature further rises is prolonged. If the drive printed circuit board 37 continuously generates heat, and the surrounding temperature sensed by the temperature sensor 47 rises to, for example, 50 to 60° C., the cooling fan 84 is driven under the control of the controller (not shown). When the cooling fan 84 is driven, forcible cooling is performed around the drive printed circuit board 37. Afterwards, when the surrounding temperature sensed by the temperature sensor 47 decreases to a predetermined level, the cooling fan 84 is stopped.

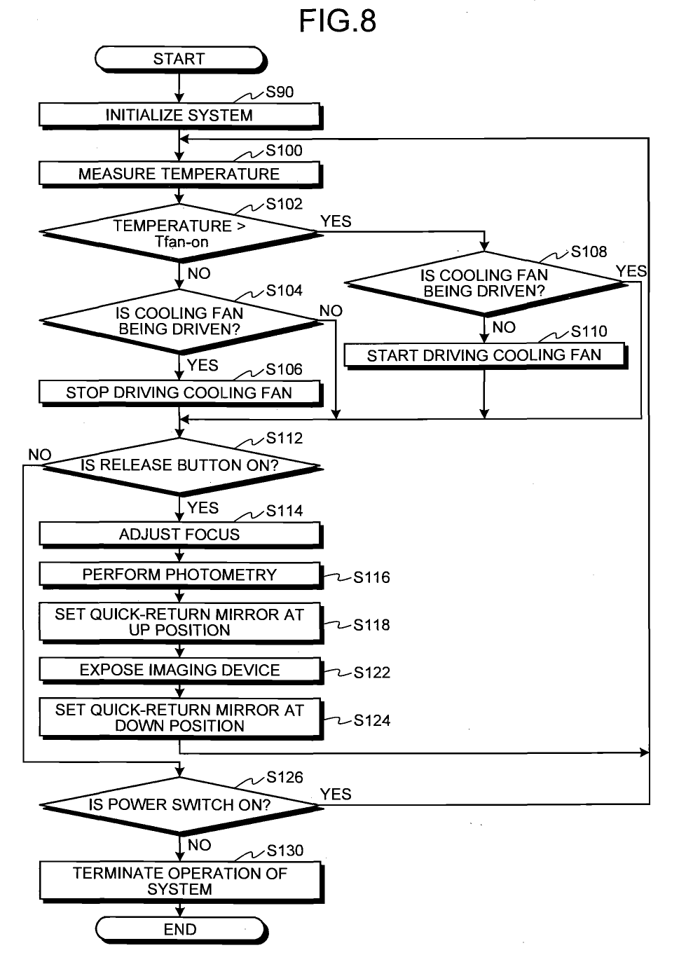

Described below is an example process of controlling the operation of the cooling fan 84 performed by the system controller 100 according to a detected temperature. FIG. 8 is a schematic flowchart of an example process of controlling the operation of the cooling fan 84 according to a detected temperature. FIG. 8 depicts only steps necessary to explain the features of the control process.

When the power switch 16, one of the camera operation switch 114, is turned on, power is supplied to the system, and the system controller 100 starts operating. Upon starting the operation, the system controller 100 initializes the system (step S90). The system controller 100 then performs A/D conversion of the output of the temperature sensor 47 received through the temperature sensing circuit 118 to measure the temperature around the drive printed circuit board 37 including the imaging device 34 (step S100). The system controller 100 determines whether the measured temperature exceeds a predetermined threshold temperature T_{fan-on} (step S102). The threshold temperature T_{fan-on} is stored in the flash ROM 113 in advance as one of the control parameters.

When the measured temperature exceeds the threshold temperature T_{fan-on} (Yes at step S102), the cooling fan 84 needs to be driven to cool the surroundings of the drive printed circuit board 37 including the imaging device 34, and the process moves to step S108. The system controller 100 determines whether the cooling fan 84 is being driven (step S108). If not (No at step S108), the system controller 100 sends a drive start signal to the cooling fan drive circuit 128 to start driving the cooling fan 84 (step S110). If the cooling fan 84 is being driven (Yes at step S108), the process moves to step S112.

On the other hand, when the measured temperature is lower than the threshold temperature T_{fan-on} (No at step S102), the process moves to step S104. The system controller 100 determines whether the cooling fan 84 is being driven (step S104). If the cooling fan 84 is being driven (Yes at step S104), the system controller 100 sends a drive stop signal to the cooling fan drive circuit 128 to stop driving the cooling fan 84 (step S106). If the cooling fan 84 is not being driven (No at step S104), the process moves to step S112. The control process from steps S100 to S110 is periodically repeated while the system is in operation. In other words, driving of the cooling fan 84 is controlled to be ON or OFF according to changes in the temperature around the drive printed circuit board 37 including the imaging device 34 (according to the operation of the imaging device 34).

Thereafter, the system controller 100 determines whether the release button 14, one of the camera operation switch 114, is ON (step S112). When the release button 14 is ON (Yes at step S112), the system controller 100 detects a defocus amount based on the output of the AF sensor unit 71 (by known phase difference focus detection). The system controller 100 notifies the lens controller 130 of the defocus amount so that the lens controller 130 adjusts the focus of the imaging lens 9 based on the defocus amount (step S114). The system controller 100 performs photometry and A/D conversion of the output of the brightness measuring circuit 111 to detect the brightness of an object (step S116). Based on this data, the system controller 100 determines exposure conditions (lens aperture value, shutter speed, etc.).

The system controller 100 controls the mirror drive circuit 124 to set the quick-return mirror 31 at the up position (step S118). The system controller 100 notifies the lens controller 130 of the lens aperture value determined at step S116 as well as controlling the focal-plane shutter 33 based on the shutter speed determined at step S116 to expose the imaging device 34 (step S122). After the exposure process, image data is read out of the imaging device 34 and is converted into a predetermined image file to be stored in the memory card 65. Subsequently, the system controller 100 controls the mirror drive circuit 124 to set the quick-return mirror 31 at the down position (step S124), and the process returns to step S100.

When the release button 14 is OFF (No at step S112), the system controller 100 determines whether the power switch 16, one of the camera operation switch 114, is ON (step S126). When the power switch 16 is ON (Yes at step S126), the process returns to step S100. On the other hand, when the power switch 16 is OFF (No at step S126), the system controller 100 terminates the operation of the system (step S130).

The following is examples of modifications of the embodiment. For example, in the embodiment described above, the cooling fan 84 is selectively driven according to a temperature sensed by the temperature sensor 47 while the temperature rise is suppressed by the use of the heat storage material 43 attached to the heatsink 35. However, the cooling fan 84 can also be selectively driven according to a temperature sensed by the temperature sensor 47 in the case of not using the heat storage material 43.

The cooling fan 84 can also be selectively driven according to the operation mode without using the temperature sensor 47. Specifically, in an operation mode in which the imaging device 34 is continuously driven and image data acquired by the imaging device 34 are sequentially processed, the drive printed circuit board 37 generates a large amount of heat, which causes temperature rise. Examples of such operation mode include continuous shooting mode in which the camera continuously captures images in a short period of time, and live view mode in which the LCD monitor 23 sequentially displays images captured by the imaging device 34 and thus can be available as the viewfinder. The continuous shooting mode and live view mode can be selected and set by a button or the like. The cooling fan 84 can be automatically driven, when the continuous shooting mode or the live view mode is set, upon lapse of a predetermined time after setting the mode. By delaying cooling operation in this manner, the electronic camera consumes less electricity.

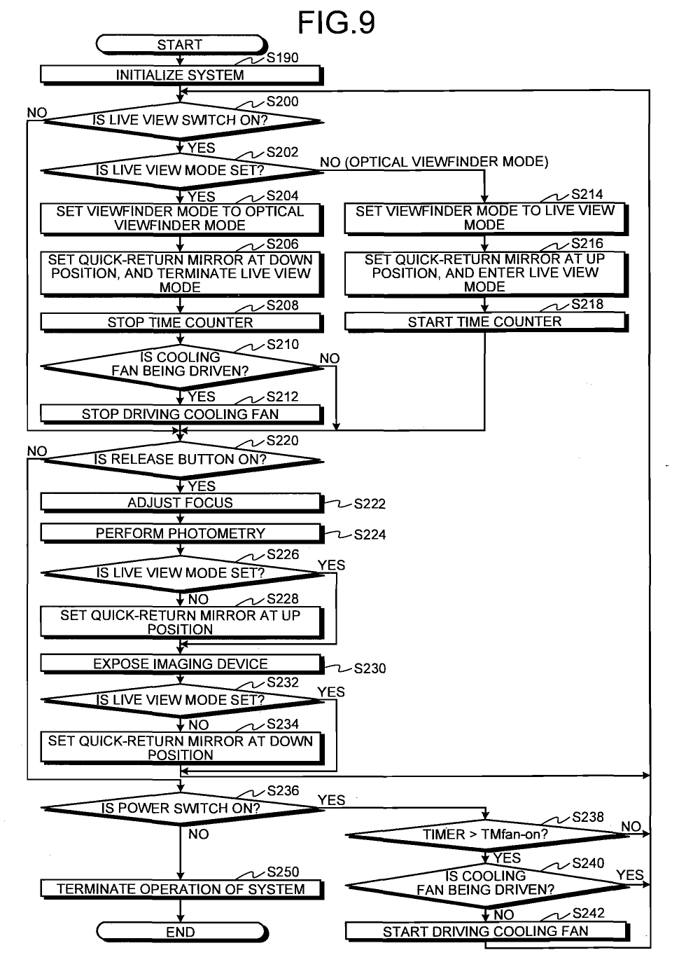

Described below is an example process of controlling the operation of the cooling fan 84 performed by the system controller 100 in the live view mode. FIG. 9 is a schematic flowchart of an example process of controlling the operation of the cooling fan 84 in the live view mode. In the live view mode, the imaging device 34 is continuously driven. This continuous operation produces an increase in the temperature of the imaging device 34. Therefore, after a predetermined time has elapsed since the start of the live view mode, the cooling fan 84 is driven to cool the surroundings of the drive printed circuit board 37 including the imaging device 34. FIG. 9 depicts only steps necessary to explain the features of the control process.

When the power switch 16, one of the camera operation switch 114, is turned on, power is supplied to the system, and the system controller 100 starts operating. Upon starting the operation, the system controller 100 initializes the system (step S190). The system controller 100 then determines whether the live view switch, one of the camera operation switch 114, is ON (step S200). When the live view switch is OFF (No at step S200), the process moves to step S220. On the other hand, when the live view switch is ON (Yes at step S200), the process moves to step S202.

At this point, according to the operation of the live view switch, two viewfinder modes are switched from one to the other. Specifically, optical viewfinder mode or live view mode is selected alternatively. In the optical viewfinder mode, an image of an object can be viewed through the optical viewfinder 28 which is a feature of the single-lens reflex camera. In the live view mode, image data of an object are acquired from the imaging device 34 at a predetermined frame rate, and images are displayed on the LCD monitor 23 based on the image data so that the images of the object can be viewed on the LCD monitor 23.

At step S202, the system controller 100 determines whether the live view mode is set as the viewfinder mode. When the live view mode is set (Yes at step S202), the system controller 100 sets the viewfinder mode to the optical viewfinder mode (step S204). Subsequently, the system controller 100 sets the quick-return mirror 31 at the down position as well as controlling the imaging device IF circuit 110 to terminate the live view mode (step S206). In addition, the system controller 100 stops the time counter that has started counting upon setting of the live view mode (step S208). The system controller 100 determines whether the cooling fan 84 is being driven (step S210). If the cooling fan 84 is being driven (Yes at step S210), the system controller 100 sends a drive stop signal to the cooling fan drive circuit 128 to stop driving the cooling fan 84 (step S212). If the cooling fan 84 is not being driven (No at step S210), the process moves to step S220.

On the other hand, when the live view mode is not set, i.e., when the optical viewfinder mode is set (No at step S202), the system controller 100 sets the viewfinder mode to the live view mode (step S214). Subsequently, the system controller 100 sets the quick-return mirror 31 at the up position as well as controlling the imaging device IF circuit 110 to acquire image data from the imaging device 34 at a predetermined frame rate. The system controller 100 then starts sending acquired image data to the LCD monitor drive circuit 127, thereby entering the live view mode (step S216). The system controller 100 also starts the time counter to measure the time from the start of the live view mode (step S218).

Thereafter, the system controller 100 determines whether the release button 14, one of the camera operation switch 114, is ON (step S220). When the release button 14 is ON (Yes at step S220), the system controller 100 detects a defocus amount based on the output of the AF sensor unit 71 (by known phase difference focus detection). The system controller 100 notifies the lens controller 130 of the defocus amount so that the lens controller 130 adjusts the focus of the imaging lens 9 based on the defocus amount (step S222). The system controller 100 performs photometry and A/D conversion of the output of the brightness measuring circuit 111 to detect the brightness of an object (step S224). Based on this data, the system controller 100 determines exposure conditions (lens aperture value, shutter speed, etc.).

The system controller 100 determines whether the live view mode is set as the viewfinder mode (step S226). When the live view mode is not set, i.e., when the optical viewfinder mode is set (No at step S226), the system controller 100 controls the mirror drive circuit 124 to set the quick-return mirror 31 at the up position (step S228). When the live view mode is set (Yes at step S226), the process skips step S228 and moves to step S230.

At step S230, the system controller 100 notifies the lens controller 130 of the lens aperture value determined at step S224 as well as controlling the focal-plane shutter 33 based on the shutter speed determined at step S224 to expose the imaging device 34. After the exposure process, image data is read out of the imaging device 34 and is converted into a predetermined image file to be stored in the memory card 65. Subsequently, the system controller 100 determines whether the live view mode is set as the viewfinder mode (step S232). When the live view mode is not set, i.e., when the optical viewfinder mode is set (No at step S232), the system controller 100 controls the mirror drive circuit 124 to set the quick-return mirror 31 at the down position (step S234). When the live view mode is set (Yes at step S232), the process skips step S234 and returns to step S200.

When the release button 14 is OFF (No at step S220), the system controller 100 determines whether the power switch 16, one of the camera operation switch 114, is ON (step S236). When the power switch 16 is ON (Yes at step S236), the process moves to step S238. At step S238, the system controller 100 determines whether the count value of the time counter exceeds a predetermined threshold time TM_{fan-on}. The threshold time TM_{fan-on} is stored in the flash ROM 113 in advance as one of the control parameters.

When the count value of the time counter (elapsed time in the live view mode) exceeds the threshold time TM_{fan-on} (Yes at step S238), the cooling fan 84 needs to be driven to cool the surroundings of the drive printed circuit board 37 including the imaging device 34, and the process moves to step S240. The system controller 100 determines whether the cooling fan 84 is being driven (step S240). If not (No at step S240), the system controller 100 sends a drive start signal to the cooling fan drive circuit 128 to start driving the cooling fan 84 (step S242). If the cooling fan 84 is being driven (Yes at step S240), the process returns to step S200.

On the other hand, when the count value of the time counter is less than the threshold time TM_{fan-on} (No at step S238), the process returns to step S200.

When the power switch 16 is OFF (No at step S236), the system controller 100 terminates the operation of the system (step S250).

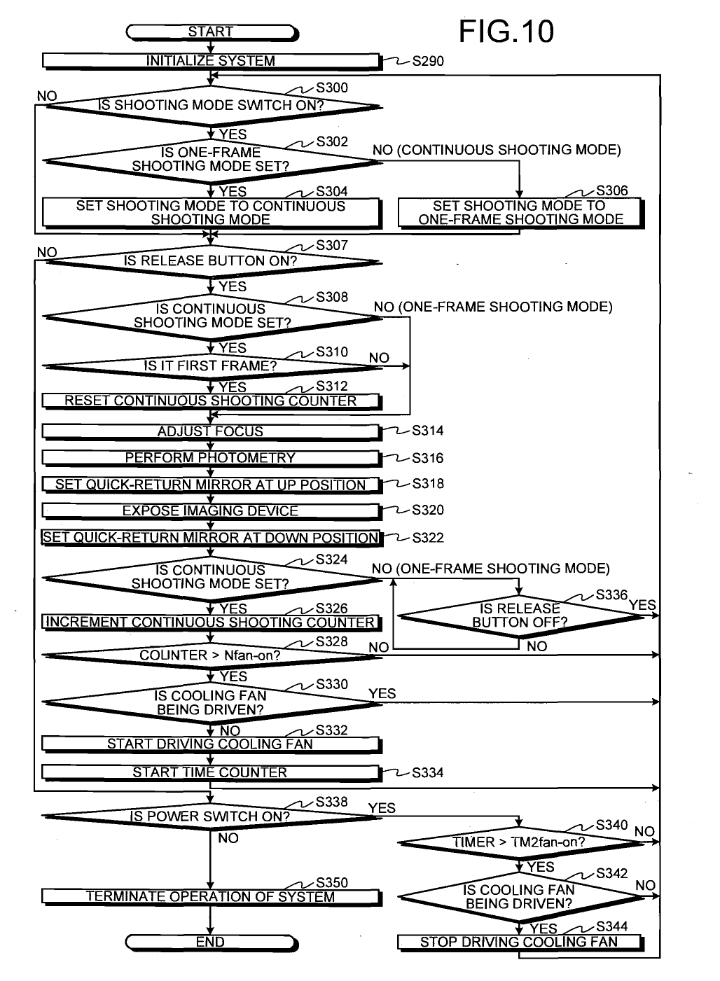

Described below is an example process of controlling the operation of the cooling fan 84 performed by the system controller 100 in the continuous shooting mode. FIG. 10 is a schematic flowchart of an example process of controlling the operation of the cooling fan 84 in the continuous shooting mode. In the continuous shooting mode, the imaging device 34 is continuously driven. This continuous operation produces an increase in the temperature of the imaging device 34. Therefore, when the number of frames in continuous shooting reaches a predetermined value, the cooling fan 84 is driven to cool the surroundings of the drive printed circuit board 37 including the imaging device 34. FIG. 10 depicts only steps necessary to explain the features of the control process.

When the power switch 16, one of the camera operation switch 114, is turned on, power is supplied to the system, and the system controller 100 starts operating. Upon starting the operation, the system controller 100 initializes the system (step S290). The system controller 100 then determines whether the shooting mode switch, one of the camera operation switch 114, is ON (step S300). When the shooting mode switch is OFF (No at step S300), the process moves to step S307. On the other hand, when the shooting mode switch is ON (Yes at step S300), the process moves to step S302.

At this point, according to the operation of the shooting mode switch, two shooting modes are switched from one to the other. Specifically, continuous shooting mode or one-frame shooting mode is selected alternatively. In the continuous shooting mode, if the release button 14 is set to ON, the continuous shooting mode is maintained and shooting is repeated. Thus, the imaging device 34 continuously operates and the temperature thereof rises. In the one-frame shooting mode, if the release button 14 is set to ON, shooting is performed only once. To perform shooting again, the release button 14 needs to be once turned off and on again. In the one-frame shooting mode, shooting is not repeated, and the temperature of the imaging device 34 is less likely to rise.

At step S302, the system controller 100 determines whether the one-frame shooting mode is set as the shooting mode. When the one-frame shooting mode is set (Yes at step S302), the system controller 100 sets the shooting mode to the continuous shooting mode (step S304). On the other hand, when the one-frame shooting mode is not set, i.e., when the continuous shooting mode is set (No at step S302), the system controller 100 sets the shooting mode to the one-frame shooting mode (step S306).

Thereafter, the system controller 100 determines whether the release button 14, one of the camera operation switch 114, is ON (step S307). When the release button 14 is ON (Yes at step S307), the system controller 100 determines whether the continuous shooting mode is set as the shooting mode (step S308). When the continuous shooting mode is not set (No at step S308), the process moved to step S314. When the continuous shooting mode is set (Yes at step S308), the system controller 100 starts continuous shooting. After that, the system controller 100 determines whether the current frame is the first frame of the shooting sequence (step S310). If the frame is the first frame (Yes at step S310), the system controller 100 resets a continuous shooting counter, which counts the number of frames in continuous shooting, to zero (step S312). Based on the count value of the continuous shooting counter, driving of the cooling fan 84 is controlled as described below. If the frame is not the first frame (No at step S310), the process moves to step S314.

The system controller 100 detects a defocus amount based on the output of the AF sensor unit 71 (by known phase difference focus detection). The system controller 100 notifies the lens controller 130 of the defocus amount so that the lens controller 130 adjusts the focus of the imaging lens 9 based on the defocus amount (step S314). The system controller 100 performs photometry and A/D conversion of the output of the brightness measuring circuit 111 to detect the brightness of an object (step S316). Based on this data, the system controller 100 determines exposure conditions (lens aperture value, shutter speed, etc.).

Subsequently, the system controller 100 controls the mirror drive circuit 124 to set the quick-return mirror 31 at the up position (step S318). The system controller 100 notifies the lens controller 130 of the lens aperture value determined at step S316 as well as controlling the focal-plane shutter 33 based on the shutter speed determined at step S316 to expose the imaging device 34 (step S320). After the exposure process, image data is read out of the imaging device 34 and is converted into a predetermined image file to be stored in the memory card 65. Next, the system controller 100 controls the mirror drive circuit 124 to set the quick-return mirror 31 at the down position (step S322).

After that, the system controller 100 determines whether the continuous shooting mode is set as the shooting mode (step S324). When the continuous shooting mode is not set, i.e., when the one-frame shooting mode is set (No at step S324), the system controller 100 forbids the process from returning to step S300 until the release button 14 is turned off. This is because, in one-frame shooting mode, shooting is performed once each time the release button 14 is turned on.

On the other hand, when the continuous shooting mode is set (Yes at step S324), the system controller 100 increments the count value of the continuous shooting counter (step S326). The system controller 100 then determines whether the count value of the continuous shooting counter exceeds a predetermined threshold count N_{fan-on} (step S328). The threshold count N_{fan-on} is stored in the flash ROM 113 in advance as one of the control parameters. When the count value of the continuous shooting counter (continuous shooting count) exceeds the threshold count N_{fan-on} (Yes at step S328), the cooling fan 84 needs to be driven to cool the surroundings of the drive printed circuit board 37 including the imaging device 34, and the process moves to step S330.

The system controller 100 determines whether the cooling fan 84 is being driven (step S330). If not (No at step S330), the system controller 100 sends a drive start signal to the cooling fan drive circuit 128 to start driving the cooling fan 84 (step S332). The system controller 100 starts the time counter to measure the time for which the cooling fan 84 is being driven (step S334). If the cooling fan 84 is configured to be stopped on completion of continuous shooting or release of the continuous shooting mode, it may stop before being driven for a sufficient period of time. In such a case, the cooling effect may not be expected. Therefore, once driven, the cooling fan 84 has to be kept driven for a predetermined period of time. If the cooling fan 84 is being driven (Yes at step S330), the process returns to step S300. Also, when the count value of the continuous shooting counter is less than the threshold count N_{fan-on} (No at step S328), the process returns to step S300.

When the release button 14 is OFF (No at step S307), the system controller 100 determines whether the power switch 16, one of the camera operation switch 114, is ON (step S338). When the power switch 16 is ON (Yes at step S338), the process moves to step S340. At step S340, the system controller 100 determines whether the count value of the time counter exceeds a predetermined threshold time TM2_{fan-on}. The threshold time TM2_{fan-on} is stored in the flash ROM 113 in advance as one of the control parameters. If the count value of the time counter exceeds the threshold time TM2_{fan-on} (Yes at step S340), it means that the cooling fan 84 has been driven for a sufficient period of time, and the process moves to step S342. The system controller 100 determines whether the cooling fan 84 is being driven (step S342). If the cooling fan 84 is being driven (Yes at step S342), the system controller 100 sends a drive stop signal to the cooling fan drive circuit 128 to stop driving the cooling fan 84 (step S344). If the cooling fan 84 is not being driven (No at step S342), the process returns to step S300.

On the other hand, if the count value of the time counter is less than the threshold time TM2_{fan-on} (No at step S340), the process returns to step S300 so that the cooling fan 84 is kept driven.

When the power switch 16 is OFF (No at step S338), the system controller 100 terminates the operation of the system (step S350).

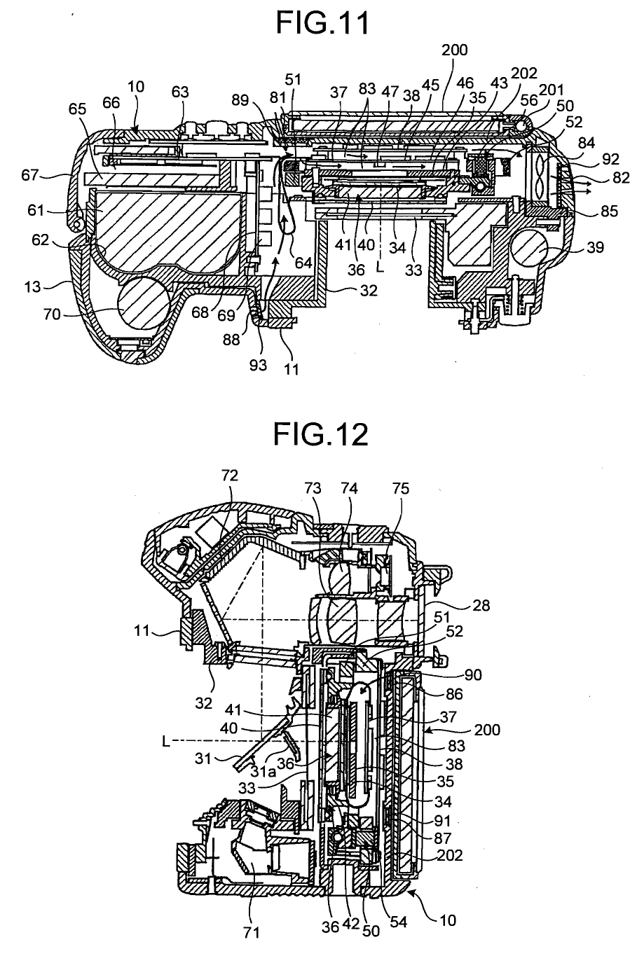

While the camera main body 10 is described above as being provided with the LCD monitor 23 fixed to the back thereof, it can be provided with a movable LCD monitor 200 as shown in FIGS. 11 and 12. FIG. 11 is a cross section taken along a horizontal plane of a camera containing an optical axis according to a modification of the embodiment. FIG. 12 is a cross section taken along a vertical plane of the camera containing the optical axis. The movable LCD monitor 200 is freely rotatable in the horizontal direction about a rotational axis 201 located at a side of the camera main body 10. In other words, the movable LCD monitor 200 is supported for pivotal motion between its open position and closed position. A universal joint (not shown), which is freely rotatable about the rotational axis 201, allows the movable LCD monitor 200 to be reversed. In this case, the camera main body 10 is provided with a back wall 202 that is slightly recessed where the movable LCD monitor 200 is set. On the back wall 202 in the state where the movable LCD monitor 200 is in the open position, the air inlets 81, 86 and 87 are formed in the periphery of the drive printed circuit board 37. That is, the air inlets 81, 86 and 87 are arranged so that they can be covered with the movable LCD monitor 200. This arrangement hardly affects the appearance of the camera as well as allowing the air inlets 81, 86 and 87 to be located as close as possible to the drive printed circuit board 37 without restriction by the movable LCD monitor 200. Thus, it is possible to effectively cool the drive printed circuit board 37.

In FIGS. 11 and 12, while the movable LCD monitor 200 is rotatable in the horizontal direction between the open position and closed position, the movement thereof is not limited as illustrated in the drawings. For example, the movable LCD monitor 200 can be rotatable in the vertical direction between the open position and closed position.

The electronic camera of the embodiment is described above as a single-lens reflex digital camera with interchangeable lenses; however, it can be, for example, a compact digital camera or a device with imaging function such as a mobile telephone and a portable information terminal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic camera comprising:
an imaging device which is located on an optical axis of an imaging lens and perpendicular to the optical axis, and on which an image of the object through an imaging lens is formed;
a heatsink that is arranged in contact with a back of the imaging device;
a drive printed circuit board that includes an imaging control device for controlling the imaging device, and is located close to the back of the imaging device;
a camera main body that houses the imaging device and the drive printed circuit board, and includes a held portion to be held by an operator, the held portion being located off the optical axis, the camera main body including a monitor that is located on the back of the imaging device;
an air inlet and an air outlet that are arranged to sandwich the drive printed circuit board in a surface direction on an outer surface of the camera main body outside the held portion such that air drawn in from the air inlet flows around the drive printed circuit board; and
a cooling fan that is located on a surface partially facing the air outlet inside the camera main body, and generates an air flow through the drive printed circuit board.

2. The electronic camera according to claim 1, wherein the air outlet is located on a side of the camera main body opposite to the held portion.

3. The electronic camera according to claim 1, wherein the air inlet is arranged at a plurality of positions around the monitor.

4. The electronic camera according to claim 1, further comprising:
a mounting member which is located on a front side of the camera main body and to which the imaging lens is detachably attached;
a battery chamber that is located inside the held portion and houses a battery;
a power source circuit board that includes a power source circuit for supply of power from the battery, and is located on a side of the optical axis partially facing the battery chamber inside the camera main body; and
a front air inlet that is located on the outer surface of the camera main body in a periphery of the mounting member such that air drawn in from the front air inlet flows around the drive printed circuit board and the power source circuit board and is released from the air outlet.

5. The electronic camera according to claim 1, wherein a heat storage material is directly attached to the heatsink.

6. The electronic camera according to claim 1, wherein the camera main body includes a filter member having air permeability for each of the air inlet and the air outlet.

7. The electronic camera according to claim 1, further comprising an imaging device shift mechanism that shifts the imaging device to compensate for shaking of the electronic camera.

8. The electronic camera according to claim 1, further comprising:
a microcomputer that controls overall operation of the electronic camera; and
a temperature sensor that senses a temperature around the drive printed circuit board inside the camera main body, wherein
the microcomputer selectively drives the cooling fan according to a temperature sensed by the temperature sensor.

9. The electronic camera according to claim 1, further comprising a microcomputer that controls overall operation of the electronic camera, wherein
the microcomputer selectively drives the cooling fan based on a time period for which the imaging device operates in continuous shooting mode.

10. The electronic camera according to claim 1, further comprising a microcomputer that controls overall operation of the electronic camera, wherein
the microcomputer selectively drives the cooling fan based on a time period for which the imaging device operates in live view mode.

11. The electronic camera according to claim 4, further comprising the imaging lens that is detachably attached to the mounting member.
